(19) United States
(12) Patent Application Publication
(10) Pub. No.: US 2007/0113876 A1
(43) Pub. Date: May 24, 2007

(54) Cleaning Apparatus

(76) Inventor: Stephen Pakenham-Walsh, Cranage (GB)

Correspondence Address: PAUL R. MORICO;BAKER BOTTS L.L.P., One Shell Plaza, 910 Louisiana, Houston, TX, 77002-4995, US

(21) Appl. No.: 11/550,093

(22) Filed: Oct. 17, 2006

Related U.S. Application Data
(63) Continuation of application No. PCT/GB05/01363, filed on Apr. 8, 2005.

(30) Foreign Application Priority Data
Apr. 17, 2004 (GB) 0408622.9

(51) Int. Cl. B08B 3/00

(52) U.S. Cl. 134/61

(57) ABSTRACT

Cleaning apparatus is provided having tray carriers (10) supported on a carousel (19) that move by means of a driven chain (18) between a collection station (21) and a washing area (22). The tray carriers (10) are operably connected on a support plate (16) of the carousel (19) and slide vertically relative thereto. The carousel (19) comprises a track (25) engaged by a roller (14) attached to the tray carriers (10). The track (25) has inclined sections between the collection station (21) and the washing area (22), whereby the tray carriers (10) are raised to the required height in the washing area (22), but are lower in the collection station (21) to suit the needs of disabled persons such as those in wheelchairs.

### CROSS REFERENCE TO RELATED APPLICATIONS

This application is a continuation of copending International Application No. PCT/GB2005/001363 filed Apr. 8, 2005 which designates the United States, and claims priority to Great Britain application No. 0408622.9 filed Apr. 17, 2004.

### TECHNICAL FIELD OF THE INVENTION

The present invention relates to a cleaning apparatus, and in particular to an apparatus for use in cleaning used crockery, cutlery and trays in eating establishments such as restaurants, workplaces, hospitals and other similar places.

### BACKGROUND OF THE INVENTION

It is a known arrangement in establishments in which large numbers of people eat to have apparatus for conveying the used crockery, cutlery and trays from a collection station in the eating area to a washing area remote from the eating area. Such apparatus comprises tray carriers supported on a carousel. The carousel is driven to move the tray carriers from the collection station to the washing area, through an opening in a wall separating the eating area from the washing area. In the collection area, trays of soiled crockery and cutlery are loaded onto the tray carriers. In the washing area, the soiled crockery, cutlery and trays are removed from the tray carriers for loading into dishwashers. To make this unloading task ergonomically efficient, the tray carriers must be at a convenient minimum height. This height governs the design of the carousel and determines the height of the tray carriers while in the collection station. However, this height of the tray carrier in the collection station may not be convenient for some people, in particular disabled people in wheelchairs and the like.

### SUMMARY OF THE INVENTION

It is an object of the present invention to provide a cleaning apparatus of the above-described type that overcomes the disadvantage of the known arrangement.

The invention provides a cleaning apparatus comprising a carousel, a tray carrier, and a support plate, wherein the tray carrier is supported on the carousel for movement therewith, the support plate is operably connected to the tray carrier and engages the carousel, and wherein the tray carrier slides vertically relative to the support plate.

The carousel may comprise a track engaged by the tray carrier, and the track may have inclined sections whereby the tray carrier is raised and lowered relative to the support plate and the carousel. The tray carrier may travel between a collection station and a washing area through openings in a wall separating the collection station and the washing area. The inclined track sections may be placed in the openings. The track may be inclined in the washing area, the collection station, or both.

The tray carrier may have a roller connected thereon in contact with the track. The roller may be connected on an arm extending through a slot in the support plate. The slot may be vertical. Alternatively, the slot may be inclined rearwardly towards the top in the direction of movement of the tray carrier.

### BRIEF DESCRIPTION OF THE DRAWING

An embodiment of the invention will be described in more detail below with reference to the appended drawings in which

FIG. 1 is a schematic side view of a tray carrier and support plate,

FIG. 2 is a schematic front view of the tray carrier and support plate of FIG. 1,

FIG. 3 is a schematic plan view of the cleaning apparatus, and

FIG. 4 is a schematic end view of the cleaning apparatus of FIG. 3.

### DESCRIPTION OF THE INVENTION

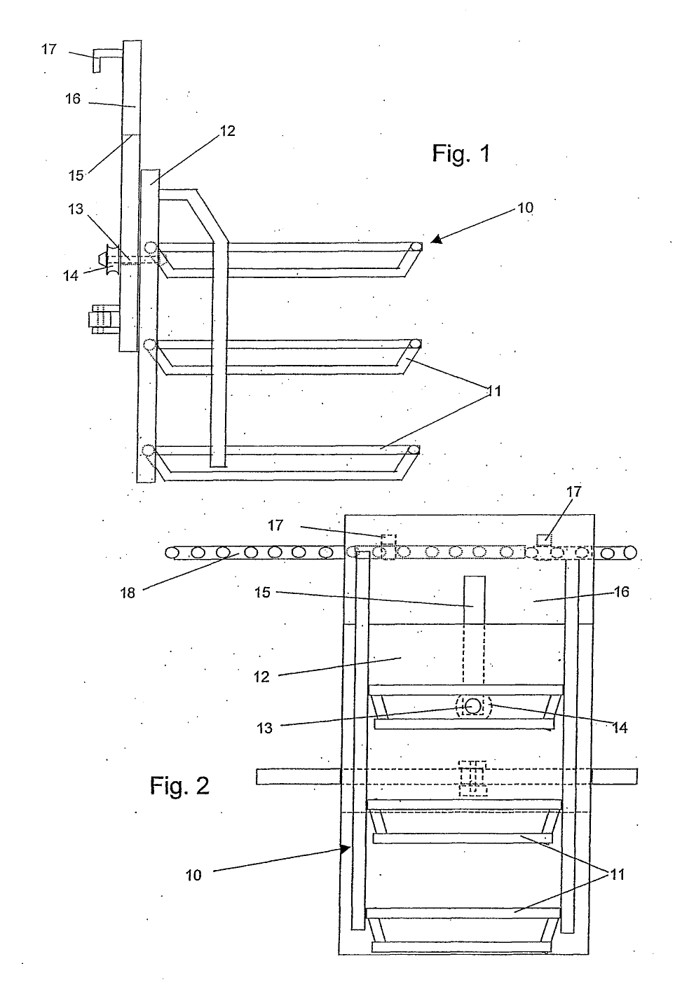

Referring now to FIGS. 1 and 2, there is shown a tray carrier 10 having three tray supports 11 disposed one above another. The tray supports 11 are mounted on a back plate 12. Secured to and extending rearwardly of the back plate 12 is an arm or spigot 13 on which is connected a roller 14. The spigot 13 passes through a vertical slot 15 in a support plate 16. By this means, the tray carrier 10 may slide vertically relative to the support plate 16 within the limits imposed by the length of the slot 15. Alternatively, the slot 15 may be inclined rearwardly towards the top in the direction of movement of the tray carrier 10 to reduce the friction between the spigot 13 and the sides of the slot 15.

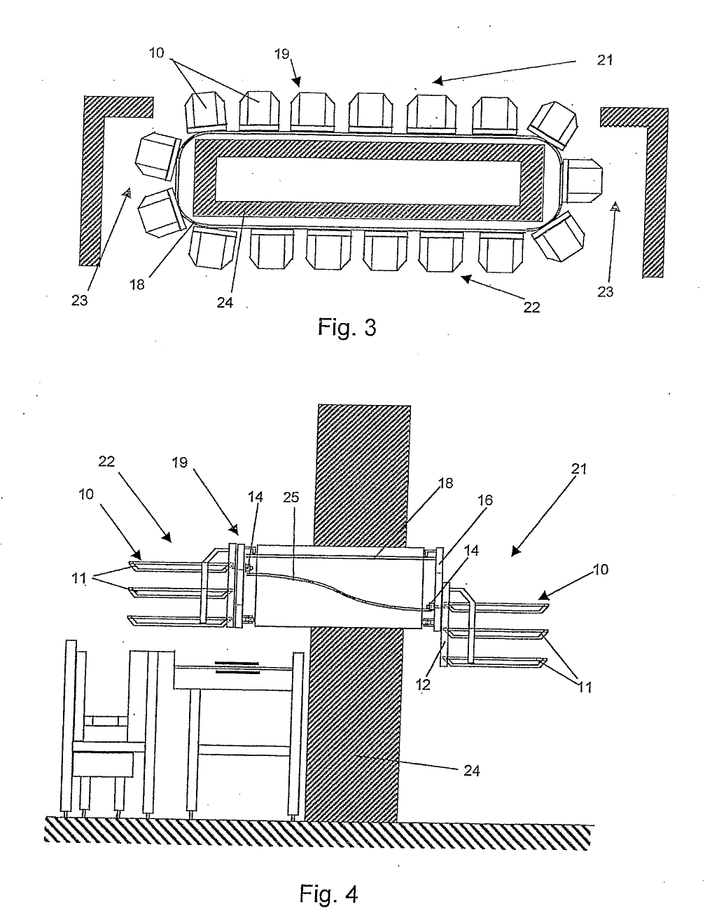

Referring now to FIGS. 3 and 4, at the rear of the support plate 16 are one or more hooks 17, which engage a chain 18 of a carousel 19. The hook or hooks 17 are secured to the support plate 16 in a manner that allows the support plate 16 and attached tray carrier 10 to traverse the comers in the path of the carousel 19. The carousel 19, which supports several tray carriers 10, extends through a collection station 21 and a washing area 22. The carousel 19 extends through openings 23 in a wall 24 separating the collection station 21 and the washing area 22. The chain 18 is driven to move the support plates 16 and tray carriers 10 around the collection station 21 and the washing area 22. Throughout the collection station 21, the washing area 22 and the openings 23, the rollers 14 of the tray carriers 10 ride on a track 25. In the openings 23, the track 25 is inclined upwardly from the collection station 21 towards the washing area 22. This causes the roller 14 and the tray carrier 10 attached thereto to rise as a tray carrier 10 passes from the collection station 21 towards the washing area 22. The weight of the tray carrier 10 causes it to descend as the tray carrier 10 moves through the other opening 23 from the washing area 22 to the collection station 21.

By this means, the tray supports 11 are at the required height in the washing area 22, but are lower in the collection station 21 to suit the needs of disabled persons such as those in wheelchairs. If desired, the track 25 may be inclined in the collection station 21, the washing area 22, or both. This will enable one group of people conveniently to load or unload the tray supports 11 at the higher end of the collection station 21 or washing area 22, while another group of people can use the lower end of the collection station 21 or washing area 22.

We claim:

1. A cleaning apparatus comprising:
a carousel, a tray carrier, and a support plate; wherein
the tray carrier is supported on the carousel for movement therewith;
the support plate is operably connected to the tray carrier and engages the carousel; and wherein
the tray carrier slides vertically relative to the support plate.

2. The cleaning apparatus according to claim 1, wherein the carousel comprises a track engaged by the tray carrier.

3. The cleaning apparatus according to claim 2, wherein the track has inclined sections whereby the tray carrier is raised and lowered relative to the support plate and carousel.

4. The cleaning apparatus according to claim 3, wherein the tray carrier travels between a collection station and a washing area.

5. The cleaning apparatus according to claim 4, wherein there is a wall separating the collection station and the washing area, the wall having openings therein, and the carousel travels between the collection station and the washing area through the openings in the wall.

6. The cleaning apparatus according to claim 5, wherein the inclined track sections are placed in the openings.

7. The cleaning apparatus according to claim 4, wherein the track is inclined in the washing area, the collection station, or both.

8. The cleaning apparatus according to claim 4, wherein the tray carrier has a roller mounted thereon in contact with the track.

9. The cleaning apparatus according to claim 8, wherein the support plate has a slot, and the roller is mounted on an arm extending through the slot.

10. The cleaning apparatus according to claim 9, wherein the slot is vertical.

11. The cleaning apparatus according to claim 9, wherein the slot is inclined rearwardly towards the top in the direction of movement of the tray carrier.

12. The cleaning apparatus according to claim 4, wherein the carousel comprises a chain, and the support plate has one or more hooks that engage the chain.

13. The cleaning apparatus according to claim 12, wherein the chain is driven to move the tray carrier between the collection station and the washing area.
